(19) United States
(12) Patent Application Publication
(10) Pub. No.: US 2002/0111272 A1
(43) Pub. Date: Aug. 15, 2002

(54) Glyphosate-induced male sterility in dicots

(75) Inventor: Richard Hall Sheetz, Plainview, TX (US)

Correspondence Address: ROTHWELL, FIGG, ERNST & MANBECK, P.C., 1425 K STREET, N.W., SUITE 800, WASHINGTON, DC, 20005, US

(73) Assignee: D&PL TECHNOLOGY HOLDING CORP., Scott, MS (US)

(21) Appl. No.: 10/004,879

(22) Filed: Dec. 7, 2001

Related U.S. Application Data
(60) Provisional application No. 60/251,581, filed on Dec. 7, 2000.

(51) Int. Cl. A01N 57/18

(52) U.S. Cl. 504/206

(57) ABSTRACT

A method is provided for producing male sterility in dicots, the method comprising applying to growing dicot plants an amount of glyphosate effective to achieve practical male sterility in the plant.

### RELATED APPLICATIONS

This application claims priority under 35 U.S.C. § 119(e) to provisional application No. 60/251,581.

### TECHNOLOGICAL FIELD

This invention relates to the fields of plant husbandry and plant breeding in dicots, and to the creation of male-sterility in cotton and other dicots.

### BACKGROUND OF THE INVENTION

It has been known for centuries that the offspring of a plant hybrid cross display increased vigor and/or yield over both parents, a phenomenon called “hybrid vigor” or “heterosis.” Such vigor is not maintained to any great degree in subsequent generations. Hybridization thus has been an invaluable tool in agriculture and horticulture and is exploited whenever possible to achieve higher productivity

Historically, however, hybridization of certain plants has been very laborious or even impossible. Because many plants are capable of self-pollination, the problem encountered is that of obtaining only seed that is the result of pollination of one parent plant by the other parent plant (“cross-pollination”) and not by either parental plant pollinating itself (“self-pollination,” or “selfing”). Cross-pollination in plants capable of self-pollination can be assured by emasculation of one parent plant, making it incapable of selfing. The emasculated plant then is exposed to pollen from a second, male-fertile parent. Emasculation can be achieved in several ways, such as physical emasculation, cytoplasmic male sterility, genetic male sterility or the use of gametocides. Each of these approaches has its drawbacks, however.

Physical emasculation, that is the removal of the male floral parts (anthers) from flowers, leaving the female floral parts (pistils), can be very labor-intensive, especially in plants that have small flower parts, numerous anthers, or that simply are grown on a large scale. Most commercial crop plants fall into one of these categories. “Detassling” has been used to produce hybrid corn, but few other commercial crops share the characteristic of corn of having anther-bearing flowers and pistil-bearing flowers on large structures occurring on different parts of the plant, enabling the relatively easy removal of the pollen-producing organs. Even in those plants where both anthers and pistils occur together, it is theoretically possible to mechanically remove the anthers. This is the common practice for producing rose hybrids, but it is commercially impractical on the scale necessary to produce a commercial crop such as soybeans or cotton. In fact, in cotton it is almost prohibitive, given the large number of anthers present in each flower, and the scale at which the hybrid seed must be produced. Cryptogamous plants, such as soybean, also present enormous difficulties to anyone attempting physical emasculation.

Cytoplasmic male sterile lines have cytoplasmic genes, usually in the mitochondria, that encode factors that disrupt or prevent pollen development, making them genetically male-sterile. The utilization of cytoplasmic male sterility for hybrid seed production requires three separate plant lines: the male-sterile line, an isogeneic male-fertile line for propagation (“maintainer line”) and a line for restoring fertility to the hybrid so that it can produce seed (“restorer line”). The male-sterile line is used as the receptive parent in a hybrid cross, the maintainer line is genetically identical to the male-sterile line, excepting that it lacks the cytoplasmic sterility factors, and the restorer line is any line that masks the cytoplasmic sterility factor. The restorer line is very important for those plants, such as grain sorghum or cotton, the useful crop of which is the seed itself or seed-associated structures. Cytoplasmic male sterile lines, however, can carry associated traits that make them vulnerable to pathogens (like the southern corn blight that attacked all corn hybrids made using cytoplasmic male sterility “T” cytoplasm). In some instances, such as in cotton, the cytoplasm has an effect on production, even on “restored” F₁ hybrids. Cytoplasmic male sterile lines simply are not available for some crops, such as soybean, or are not available in any quantity. There is also a problem with loss in yield associated with the use of cytoplasmic male sterility systems, as high as 10%-12% in cotton by some estimates.

Genetic male sterility is similar to cytoplasmic male sterility, but differs in that the sterility factors are encoded in nuclear DNA. Genetic male sterile plant lines occur naturally. It is also possible to create a male-sterile plant line using recombinant techniques. U.S. Pat. No. 5,086,169 discloses the use of a pollen-specific promoter linked to a “suicide” gene and transfected into a plant to create artificial male-sterility. Whether naturally-occurring or transgenic, male-sterile lines still require the use of a sister maintainer line for their propagation, which of necessity leads to a minimum of 50% male-fertile plants in propagated seed. This is a result of the genetics of male-sterility and maintainer lines. If the male-sterility factor is recessive, as most are, a male-sterile plant would have to be homozygous recessive in order to display the trait. The maintainer line must be heterozygous to maximize the number of homozygous recessive offspring during propagation. The maximum percentage of homozygotes from a homozygote/heterozygote cross is 50% (assuming Mendelian genetics, a 1:1 ratio of homozygotes to heterozygotes). This means that half of the plants grown from the propagated “male-sterile” seed will actually be male-fertile. To prevent selfing, the male-fertile plants have to be removed before anther maturation, a process called “roguing.” This can be very labor-intensive and is generally prohibitive of use on a commercial scale.

Gametocides are chemicals that disrupt pollen development or prevent pollen release. Application of a gametocide to a plant renders it effectively male-sterile. However, presently known gametocides are not 100% effective, leading to persistent amounts of male-fertile plants that self-pollinate, in turn leading to contamination of the hybrid seed with selfed seed. Presently known gametocides generally are toxic and must be carefully applied to prevent outright sterilization or even killing of the plant, as well as to prevent emasculation of nearby plants that may be needed as a pollen source. Furthermore, gametocides can be expensive to use, particularly on plants that have indeterminant (continuous) flowering, necessitating repeated applications to assure continued emasculation of the plant. Therefore, a need exists for an effective plant male gametocide that has low toxicity, low cost, and can be applied easily.

The herbicide glyphosate (Roundup®, Monsanto Co., St. Louis, Mo.) has been used for years as an agricultural herbicide. It has high phytotoxic activity, yet low toxicity to animals, and is rapidly broken down in the environment. Several naturally glyphosate-tolerant crop lines are known, and a number of genes conferring tolerance to glyphosate have been identified and cloned into a variety of plants. There are currently commercially available varieties of corn, cotton and soybeans having tolerance to glyphosate conferred through recombinant technology. Glyphosate has not been reported previously to have gametocidic activity.

### SUMMARY OF THE INVENTION

A new and efficient method has been discovered, that provides practical male sterility in cotton and other dicots. It has been found that regular applications of the herbicide glyphosate to glyphosate-tolerant plants, commencing at least 30 days post planting and continuing in at least about 10 day intervals, renders the cotton plants effectively male sterile, as measured by pollen production and natural pollen shed. This male sterility remains in effect as long as applications are continued. The method is a reliable, efficient and cost-effective way of providing male-sterile plants for such uses as the production of F1 and F2 cotton hybrids.

### DETAILED DESCRIPTION

It has been found that a regular course of applications of glyphosate to growing glyphosate-tolerant dicot plants (for example any of the “Roundup Ready®” varieties of cotton or soybean available from Delta & Pine Land, Stoneville, and others, such as Paymaster 2326 RR, Paymaster 2200 RR, DP 7220 RR, DP 6299 RR and DP 5414 RR leads to effective male sterilization of the plant. The method of the present invention can be practiced by applying glyphosate at a rate of from about 16 ounces per acre to about 64 ounces per acre, preferably from about 16 oz/acre to about 32 oz/acre, most preferably at about 24 oz/acre. Lower rates of application are possible, and can be determined by routine experimentation (for example daily applications at a low concentration). The basic constraint on a lower limit to the application rate is practicality, cost and convenience.

Applications are applied in multiple applications at intervals of 5 to 30 days, preferably at intervals of 5 to 20 days, and most preferably at intervals of about 10 days. Applications are commenced preferably about 30 days post planting, or as soon the first squares (flower buds) appear. Applications should continue until the last date that one would expect viable seed to set (thus, application could continue until harvest, as a practical matter it can be stopped at a point where self-pollination could occur, but when too little time remained before harvest to form a viable seed, since no viable contaminating selfed seed would form). Preferably, applications should continue until about 60 days prior to the expected harvest date. Rates and application frequencies appear to work together in that it is ultimately the concentration of glyphosate in the plant that determines the level of male sterility observed. In other words lower rates at shorter intervals can be substituted for higher rates with less frequent applications. The plants do not metabolize the glyphosate herbicide, rather it is the plant growth that ultimately dilutes the chemical concentration and reduces its ability to affect male fertility. The means by which the glyphosate is applied does not form a part of this invention, and can be any of a variety of convenient means known to persons of ordinary skillin the art.

A male gametocide system as complete, consistent, and non-phytotoxic as this one has never before been available to breeders. This system is far superior to systems currently in use to produce the F1 seed necessary to produce F2 hybrids, some of which have resulted in serious female sterility and germination problems in the F1 seed. With the present invention it is possible to prepare entire rows, plots or fields of male-sterile dicots, easily and at low cost. By leaving adjacent rows, plots or fields untreated, or treated at a rate below the gametocidic threshold of glyphosate, as a pollen source, cross-pollination (i.e. hybridization) in the treated plots is assured. An example of an application below the gametocidic threshold is application in accordance with the label instructions on Roundup® (a maximum of 2 “over the top” applications of 32 oz/acre before the 5th true leaf reaches the size of a quarter, at least 10 days apart). The maximum recommended Roundup® applied per season is 4 quarts: 2 “over the top” and 2 post directed (with shielded sprayers to avoid spraying on the cotton plants). This rate has never been reported to produce male sterility in dicots.

The method of the present invention should be applied to varieties that are tolerant to the herbicide glyphosate, either naturally or as a result of transfection with a gene that confers glyphosate tolerance. Examples of cotton varieties on which the invention method can be used are RR 1445 (Coker 312), from Monsanto, Co. (St. Louis, Mo.), and Paymaster 2326 RR and Paymaster 2200 RR, From Delta & Pine Land Company (Scott, Mich.). Examples of soybean varieties on which the invention method can be used are SG 498 RR, DP 4690 RR, DP 5806 RR and DP 6880 RR. Glyphosate-tolerant varieties of other dicots are readily identified from the literature, and further are available through the application of standard molecular techniques to produce transgenic plants tolerant to glyphosate. See, e.g., U.S. Pat. No. 4,940,835 (Shah et al.); U.S. Pat. No. 5,145,783 (Kishore, et al.); U.S. Pat. No. 5,804,425 (Barry, et al.). In one preferred embodiment, the pollen donor plant is tolerant to a second herbicide (e.g. Bromoxinil), so that hybrids can be readily identified among the progeny by application of both herbicides.

Recent studies have clearly shown a small but measurable difference in varietal response to the glyphosate applications. Two Roundup Ready® Paymaster cotton varieties have been used in field tests of the method of the present invention, and they show a definite difference in the level of male sterility induced. In both cases the sterility was adequate for hybrid production. It would therefore be necessary to fine tune the rates and or application frequencies somewhat from one “female parent” to another, as needed, for a particular variety.

Among the potential uses of the present invention is in the production of F1 hybrids. One of the difficulties involved in, for example, cotton hybrid breeding programs involving the Gossypium harkenessii cytoplasmic male sterility system is the loss in yield (10-12% by some estimates). By taking advantage of the present invention, this loss of yield would be completely eliminated. By using the methods of the present invention, F1 hybrids can be produced reliably in cotton and other dicots, at low cost and in any quantity.

Another potential use of the present invention is the production of F2 hybrids in cotton and other dicots. Various F2 combinations within commercial cotton germplasm (e.g., Paymaster) appear to be viable products if an economical system for producing F1 seed were available. F2 hybrids have shown increases in yield of 10-13% above the highest-yielding varieties, and additionally have shown a very high degree of consistency in performance across years and locations. The present invention provides the method for producing both the F1 parental lines, as well as the final F2 cross itself.

Another potential use is the simple and easy production of many different segregating populations from which new and novel true breeding open-pollinated varieties may be selected.

Other uses for the present invention will be apparent to persons skilled in the art, and include any use in which dicot male sterility would be useful or advantageous.

### EXAMPLE 1

A test was designed to determine whether glyphosate-induced male sterility in cotton could be reliably maintained throughout the blooming period.

The plant material used was a glyphosate-tolerant variety (RR1445) of Coker 312 obtained from Monsanto Co. (St. Louis, Mo.). Seed was planted in 25 foot long, single row plots, with a 38 inch row spacing. The test was replicated four times with treatments applied as follows:

Treatment 1: Single spray at 30 days post planting (“30 DPP”);

Treatment 2: Multiple sprays beginning at 30 DPP and repeating every 10 days (“30 DPP+10 D”)

Treatment 3: Multiple sprays beginning at 30 DPP and repeating every 20 days (“30 DPP+20 D”)

Treatment 4: Unsprayed control.

The sprays consisted of a single 2% solution of Roundup® brand glyphosate (41% formulation), which was equivalent to 20 ml/l, or 22/3 oz/gal. This solution was used in all spray treatments, and was applied to runoff. The application resulted in an application rate of about 64 ounces per acre. At the onset of bloom (mid-July) and through mid September, each plot was scored for fertility approximately every 5 days as follows:

0=Complete sterility; no pollen present upon rubbing anthers between fingers;

1=Practically no pollen present upon rubbing anthers, no self pollination possible because anthers never shed pollen, male-sterile for all practical purposes;

2=Very little pollen upon rubbing anthers, no natural pollen shed, no self pollination possible, male sterile for all practical purposes;

3=Some pollen present when anthers rubbed, a minimal amount of natural pollen shed on lower anthers, a very small amount of self pollination possible with insect activity;

4=Anthers shed pollen in sufficient amounts at all anther levels to self pollinate;

5=Anthers shed pollen in normal amounts from all anthers.

The fertility scores for all treatments are presented in Table 1. Practical sterility is defined as a score of 2.75 or below and includes all flowers which do not shed naturally throughout the day regardless of whether or not pollen can be extracted from the anthers by mechanical damage.

TABLE 1
Fertility Scores in Glyphosate Tolerant Construct 1445

| Treat- | Days Post Planting | | | | | | | | |
|---|---|---|---|---|---|---|---|---|---|
| ment | 58 | 62 | 66 | 70 | 75 | 80 | 85 | 90 | 104 |
| 30 DPP | 1.00 | 3.00 | 3.75 | 4.00 | 4.25 | 4.50 | 5.00 | 5.00 | 5.00 |
| 30 | 1.00 | 1.00 | 1.00 | 1.00 | 1.00 | 1.25 | 1.25 | 1.25 | 1.25 |
| DPP + | | | | | | | | | |
| 10 D | | | | | | | | | |
| 30 | 1.00 | 1.75 | 2.5 | 2.75 | 2.5 | 1.75 | 1.75 | 1.50 | 1.50 |
| DPP + | | | | | | | | | |
| 20 D | | | | | | | | | |
| Control | 5.00 | 5.00 | 5.00 | 5.00 | 5.00 | 5.00 | 5.00 | 5.00 | 5.00 |

The data shows that treatments 2 (30 DPP+10 D) and 3 (30 DPP+20 D), are adequate to induce sterility in the tolerant construct RR1445. The 10 day interval provides the most effective gametocidic effect, well below the threshold for practical male-sterility, while the 20 day interval also provides practical male sterility, though closer to the threshold.

No adverse effects of the multiple sprays (other than male sterility) were noted throughout the season. The plots corresponding to the higher sterility scores were significantly taller; however, this can be attributed to the physiological effect of not having a boll set.

### EXAMPLE 2

A small isolated crossing block was planted with variety Paymaster 145 RR. Glyphosate was applied as indicated in the previous Example. The intention was to maintain male sterility and to cross pollinate (manually) with pollen from another Paymaster variety to produce actual F1 hybrid seed.

At the end of the season it was noted that practically all hand pollinated flowers had not set viable bolls. A few had set partial bolls, that is bolls in which the full complement of fertilized seeds was not present, but in general the seed set was not adequate to commercially produce hybrid seed. This was interpreted as an indication of female sterility, very possibly due to excessive glyphosate applications (in frequency and/or dose).

### EXAMPLE 3

A further test was conducted using the varieties PM 2200 RR and PM 2326 RR, in which 4 levels of glyphosate spray rates were applied at 14 day intervals, beginning at 31 days post planting. The rates used were: 0, 16, 24 and 32 ounces/acre of glyphosate. Fertility scores were taken at roughly 2 day intervals during the season to follow male sterility development. At the same time hand pollination was done on 10 flowers in each treatment (all 3 replicates), also at 2 day intervals for a total of “10 crossing days”. This was to determine the amount of seed set under the various spray regimes and thus infer the degree of female sterility, if any, being induced by the glyphosate applications.

The test data showed that it is in fact very easy to induce male sterility on a level comparable with the work described in Example 1, at rates that are considerably lower than the 2% solution (about 64 oz/acre) used in Examples 1 and 2. All rates used produced male sterility, but a 24 oz/acre rate at roughly 10 day intervals provided the best effect with minimal or no female sterility. Full, mature bolls bearing hybrid seed were produced at all the spray rates tested.

A small but measurable difference in varietal response to the glyphosate applications was found. Two Roundup Ready® Paymaster varieties (PM 2200 RR and PM 2326 RR) were used in this test and they showed a definite difference in the level of male sterility induced. In both cases the sterility was adequate for hybrid production.

### EXAMPLE 4

The glyphosate-tolerant soybean varieties DP 7220 RR, DP 6299 RR and DP 5414 RR were planted in replicated four row plots 18 feet in length, at planting and during growing season, end trimmed to 14.5 feet just prior to harvest to remove end effects in yield. Glyphosate (RoundUp® Ultra Max, Monsanto Co.) was applied starting 14 days post planting, with 5 applications at approximately 10 day intervals thereafter. The sprays consisted of a single 2% solution of the RoundUp® Ultra Max commercial glyphosate product, which is a 50% solution of glyphosate. This is equivalent to 16.25 ml/l or 2.17 oz/gal. This solution was used for all treatments, and was applied to runoff. Four rates of application were used: 0 ounces/acre (oz/acre) (control), 13.5 oz/acre (equivalent to the 16 oz/acre of the 41% formulation used in Examples 1-3), 26 oz/acre (equivalent to the 32 oz/acre used for Examples 1-3) and 52 oz/acre (equivalent to the 64 oz/acre used for Examples 1-3).

The two middle rows of each plot were harvested for yield, calculated in bushels/acre (bu/acre) based on this land area. Statistical significance was determined using a standard single-tailed T-test. Male sterility was assessed based on the yield, because soybean is a cryptogamous flower (the flowers never open until after fertilization), and thus is almost completely self-pollinated. A statistically significant reduction in the yield would therefore correlate with a decreased rate of fertilization. Pollen production was not assessed in this experiment, but based on the observations made in cotton (Examples 1-3), it is reasonable to conclude that the decrease in fertilization rate in soybeans was due to a decrease in viable pollen production.

The results of this experiment are set forth in Table 2. For each variety, there was a highly statistically significant reduction in yield in glyphosate treated plots versus control at application rates of 26 oz/acre or higher. For DP 7220 RR, an application rate of 13.5 oz/acre gave a statistically significant reduction in yield. All varieties showed a tight correlation between increased glyphosate application rate and decreased yield (whether or not the decrease in yield was statistically significant).

TABLE 2
Effect of increasing concentrations of
glyphosate on soybean yield

| | | | Average | |
|---|---|---|---|---|
| | | | Difference | |
| | Application | | from | |
| Soybean | rate | Yield | Control | Level of |
| Variety | (oz./acre) | (bu/acre) | (oz./acre) | significance¹ |
| DP 7220 RR | 0 | 40.00 | — | — |
| | 13.5 | 35.95 | 4.05 | * |
| | 26 | 31.73 | 8.27 | *** |
| | 52 | 28.45 | 11.55 | *** |
| DP 6299 RR | 0 | 37.68 | — | — |
| | 13.5 | 36.45 | 1.23 | ns |
| | 26 | 28.03 | 9.65 | *** |
| | 52 | 27.50 | 10.18 | *** |
| DP 5414 RR | 0 | 34.58 | — | — |
| | 13.5 | 32.53 | 2.05 | ns |
| | 26 | 26.28 | 8.30 | *** |
| | 52 | 25.93 | 8.65 | *** |

¹Level of Significance
ns = no statistical difference
* = <0.05
** = <0.01
*** = <0.001
LSD = 3.3258;
S.E.D. = 1.9652;
Heritability = 0.917;
t(one-sided a = 0.050, 33 df) = 1.6924;
MSE = 7.72390

While complete male-sterility was not achieved in this experiment, the clear trend of significantly decreased yield with increased glyphosate application rates, coupled with previous observations in cotton, leads to the conclusion that complete, or near-complete, male-sterility can be achieved by optimizing application rate, frequency, and number of applications. Determination of the optimum rate to obtain such sterilization would be a matter of routine experimentation.

I claim:

1. A method for producing male sterility in a dicot plant comprising applying to a growing dicot plant an amount of glyphosate effective to achieve practical male sterility in the plant.

2. The method of claim 1 wherein the glyphosate is applied starting at 30 days post planting, and thereafter at intervals of 5-30 days.

3. The method of claim 2 wherein the glyphosate is applied at intervals of 5-20 days.

4. The method of claim 3 wherein the glyphosate is applied at intervals of 10 days.

5. The method of claim 1 wherein the glyphosate is applied at a rate of from about 16 ounces per acre to about 64 ounces per acre.

6. The method of claim 5 wherein the glyphosate is applied at a rate of from about 16 ounces per acre to about 32 ounces per acre.

7. The method of claim 6 wherein the glyphosate is applied at a rate of about 24 ounces per acre.

8. The method of claim 1, wherein the dicot plant is selected from the group consisting of cotton and soybean.

9. The method of claim 8, wherein the dicot plant is cotton.

10. The method of claim 9 wherein the glyphosate is applied starting at 30 days post planting, and thereafter at intervals of 5-30 days.

11. The method of claim 10 wherein the glyphosate is applied at intervals of 5-20 days.

12. The method of claim 11 wherein the glyphosate is applied at intervals of 10 days.

13. The method of claim 9 wherein the glyphosate is applied at a rate of from about 16 ounces per acre to about 64 ounces per acre.

14. The method of claim 13 wherein the glyphosate is applied at a rate of from about 16 ounces per acre to about 32 ounces per acre.

15. The method of claim 14 wherein the glyphosate is applied at a rate of about 24 ounces per acre.

16. The method of claim 8, wherein the dicot plant is soybean.

17. The method of claim 16 wherein the glyphosate is applied starting at 30 days post planting, and thereafter at intervals of 5-30 days.

18. The method of claim 17 wherein the glyphosate is applied at intervals of 5-20 days.

19. The method of claim 18 wherein the glyphosate is applied at intervals of 10 days.

20. The method of claim 16 wherein the glyphosate is applied at a rate of from about 16 ounces per acre to about 64 ounces per acre.

21. The method of claim 20 wherein the glyphosate is applied at a rate of from about 16 ounces per acre to about 32 ounces per acre.

22. The method of claim 21 wherein the glyphosate is applied at a rate of about 24 ounces per acre.
